(19) United States
(12) Patent Application Publication
(10) Pub. No.: US 2019/0270880 A1
(43) Pub. Date: Sep. 5, 2019

(54) CURABLE EPOXIDE/POLYURETHANE HYBRID RESIN SYSTEM FOR SMCS

(71) Applicant: Henkel AG & Co. KGaA, Duesseldorf (DE)

(72) Inventors: Christian Holtgrewe, Duesseldorf (DE); Harald Kuester, Duesseldorf (DE); Markus Sumser, Heme (DE); Ligang Zhao, Duesseldorf (DE)

(21) Appl. No.: 16/416,864

(22) Filed: May 20, 2019

Related U.S. Application Data
(63) Continuation of application No. PCT/EP2017/079882, filed on Nov. 21, 2017.

(30) Foreign Application Priority Data
Nov. 22, 2016 (EP) 16199906.5

(51) Int. Cl. C08L 63/00; C08L 75/08; C08J 5/18; C08J 5/24; B29C 70/50

(52) U.S. Cl. CPC C08L 63/00; C08L 75/08; C08J 5/18; C08J 5/24; B29K 2063/00; C08J 2363/02; C08J 2463/02; C08J 2375/08; C08J 2475/08; B29C 70/50

(57) ABSTRACT

The present invention relates to a curable epoxide/polyurethane hybrid resin system comprising an epoxide resin, a polyurethane and a latent curing agent for the epoxide resin and having a viscosity which makes the hybrid resin system suitable for use in the SMC (sheet molding compound) range. The invention also relates to the use of said resin systems for smc applications, to methods for producing fiber-reinforced composite materials using the claimed resin systems and to the thus obtained fiber-reinforced composite material and construction and moulding materials.

The present invention relates to a curable epoxy/polyurethane hybrid resin system containing an epoxy resin, a polyurethane and a latent curing agent for the epoxy resin and having a viscosity which makes the hybrid resin system suitable for SMC (sheet molding compound) applications. Furthermore, the invention relates to the use of such resin systems for SMC applications, methods for the production of fiber composites using the described resin systems and the fiber composites and structural and molded parts thus obtained.

Sheet molding compounds (SMCs) are fiber-matrix semi-finished products, which are produced as plate-like, dough-like molding compounds from thermosetting reaction resins and glass fibers. In SMCs, all the necessary components are completely pre-mixed, ready for processing. In general, polyester or vinyl ester resins are used in combination with fillers. The reinforcing fibers are typically present as cut fibers, more rarely in mat or fabric form.

The fully automatic mixing of the resin filler mixture with the glass fibers produces the SMC semi-finished product in foil form. This can then be cut and further processed by extrusion to the finished component. SMC serves for the production of body parts for cars, sports equipment, parts for the electrical, plumbing and aerospace industries. During pressing, complex shapes can be filled in one step and fasteners can already be inserted into the mold. This makes SMC particularly economical. The fillers are primarily used to reduce costs, depending on the filler also for weight reduction or for changing other physical properties.

Because of their superior strength and toughness compared to classical unsaturated resins, epoxy resins would be particularly desirable as thermoset compositions for SMC applications. At present, however, it is not possible to use epoxy resins because the viscosities thereof are too low at the temperatures prevailing during pressing. The SMC process requires special viscosity profiles. Thus, the resins used must have high viscosities both at room temperature and at the pressing temperature of 150-160° C. in order to be used and to meet the performance requirements of the parts thus produced. Even partially cured epoxy resins, so-called B-stage resins which have been pre-cured, for example with an amine curing agent, currently do not have suitable viscosities. In addition, there is the problem that such partially cured resins usually have to be stored refrigerated.

The present invention overcomes the known disadvantages of epoxy resin compositions and is based on the inventors' finding that the suitability of epoxy resins for SMC applications can be overcome by the use of hybrid resin systems containing a polyurethane in addition to the epoxy resin. Such hybrid resins show similar viscosity curves to classic SMC resins. In addition, the stability is not significantly reduced by the addition of polyurethanes.

The present invention therefore relates, in a first aspect, to a curable epoxy/polyurethane hybrid resin system for SMC (sheet molding compound), characterized in that the hybrid resin system comprises:

(1) at least one epoxy resin,
(2) at least one polyurethane; wherein the at least one polyurethane is obtainable by reacting a reaction mixture comprising:

(a) at least one polyisocyanate;

(b) at least one polyol, in particular at least one triol; and

(c) at least one catalyst for the synthesis of polyurethane; and
(3) at least one latent curing agent for the epoxy resin;
wherein the hybrid resin system at a temperature of 150° C. has a viscosity of at least 100 Pas, preferably at least 500 Pas.

The present invention, in another aspect, relates to the use of the resin systems described herein as matrix resin in SMCs, and to the production of SMCs, and the fiber composites and fiber reinforced structural and molded parts made using the resin systems described herein, and related methods of production.

“At least one,” as used herein, refers to 1 or more, for example 1, 2, 3, 4, 5, 6, 7, 8, 9 or more. In connection with components of the compositions described herein, this information does not refer to the absolute amount of molecules, but to the type of the component. “At least one polyol” therefore signifies, for example, one or more different polyols, which is to say one or more different types of polyols. Together with stated amounts, the stated amounts refer to the total amount of the correspondingly designated type of component, as defined above.

“Liquid”, as used herein, denotes compositions that are flowable at room temperature (20° C.) and normal pressure (1013 mbar). Accordingly, “solid” means solid compositions at room temperature (20° C.) and normal pressure (1013 mbar).

The viscosity of the resin systems described herein is high enough at the temperatures used in SMC processes, i.e. in the range from 150 to 160° C., that the compositions can be used in the presses, do not run out of molds and at the same time can sufficiently wet and impregnate fiber materials, such as are used for fiber reinforced plastic parts. In various embodiments, the reaction mixture at a temperature of 150° C. has a viscosity of at least 100 Pas, preferably at least 500 Pas. To determine the viscosity, the resin mixture is prepared at room temperature with a suitable mixer and the mixture is pre-cured for 1 h at 80° C. in a convection oven. Subsequently, the temperature-dependent viscosity is determined by means of a plate/plate rheometer at a heating rate of 10 K/s in the range from 20 to 200° C. in oscillation at 100 rad/s at a deformation of 1%.

In a preferred embodiment, directly after mixing without pre-curing of the components at 20° C., the hybrid resin system for SMC has a viscosity (measured by plate/plate rheometer in oscillation at 100 rad/s) between 5 and 50 Pas, preferably between 10 and 40 Pas. A corresponding viscosity is particularly advantageous for excellent wetting of the fibers while maintaining the stability of the system.

The epoxy resin may comprise epoxide group-containing monomers, prepolymers and polymers as well as mixtures thereof, and is also referred to in the following as epoxide or epoxide group-containing resin. Basically, such epoxy resins include saturated, unsaturated, cyclic or acyclic, aliphatic, alicyclic, aromatic or heterocyclic polyepoxide compounds. “Epoxide groups” as used herein refers to 1,2-epoxide groups (oxiranes). Suitable epoxide group-containing resins are in particular resins having 1 to 10, preferably 2 to 10 epoxide groups per molecule.

The epoxy resins usable herein may vary and include conventional and commercially available epoxy resins, each of which may be used individually or in combination of two or more different epoxy resins. In selecting the epoxy resins, not only the properties of the final product but also the properties of the epoxy resin such as the viscosity and other properties that affect processability are important.

The epoxide group-containing resin is preferably an aromatic, in particular also liquid epoxy compound. Examples of suitable resins include, without being limited thereto, (poly)glycidyl ethers, which are usually obtained by reacting epichlorohydrin or epibromohydrin with polyphenols in the presence of alkali, or also (poly)glycidyl ethers of phenol formaldehyde novolac resins, alkyl-substituted phenol formaldehyde resins (epoxy novolac resins), phenol-hydroxybenzaldehyde resins, cresol-hydroxybenzaldehyde resins, dicyclopentadiene phenol resins and dicyclopentadiene-substituted phenol resins. Suitable polyphenols for this purpose are, for example, resorcinol, pyrocatechol, hydroquinone, bisphenol A (2,2-bis(4-hydroxyphenyl) propane), bisphenol F (bis(4-hydroxyphenyl) methane), 1,1-bis(4-hydroxyphenyl) isobutane, 4,4-dihydroxybenzophenone, 1,1-bis(4-hydroxyphenyl) ethane and 1,5-hydroxynaphthalene. Also suitable are diglycidyl ethers of ethoxylated resorcinol (DGER), diglycidyl ether of resorcinol, pyrocatechol, hydroquinone, bisphenol, bisphenol A, bisphenol AP (1,1-bis(4-hydroxyphenyl)-1-phenylethane), bisphenol F, bisphenol K, bisphenol S, and tetramethyl bisphenol.

Other suitable epoxy resins are known in the prior art and can be found, for example, in Lee H. & Neville, K., Handbook of Epoxy Resins, McGraw-Hill Book Company, 1982 reprint.

Particularly preferred epoxide group-containing compounds are aromatic glycidyl ethers, in particular diglycidyl ethers, most particularly preferably those based on aromatic glycidyl ether monomers. Examples thereof are, without limitation, di- or polyglycidyl ethers of polyhydric phenols, which can be obtained by reacting a polyhydric phenol with an excess of chlorohydrin such as epichlorohydrin. Polyhydric phenols of this kind include resorcinol, bis(4-hydroxyphenyl)methane (bisphenol F), 2,2-bis(4-hydroxyphenyl)propane (bisphenol A), 2,2-bis(4′-hydroxy-3′,5′-dibromophenyl)propane, 1,1,2,2-tetrakis(4′-hydroxyphenyl)ethane or condensates of phenols with formaldehyde, which are obtained under acidic conditions, such as phenol novolacs and cresol novolacs.

Diglycidyl ethers of bisphenol A are available for example as DER 331 (liquid bisphenol A epoxy resin) and DER 332 (diglycidyl ether of bisphenol A) from Dow Chemical Company, Midland, Mich. Although not specifically mentioned, other epoxy resins which are available under the trade names DER and DEN from Dow Chemical Company may also be used.

It may be preferred according to the invention that the epoxy resin used is substantially free of hydroxyl groups. Epoxy resins are substantially free of hydroxyl groups if they have a hydroxy equivalent weight of at least 4000 g/eq, such as, for example, the product marketed under the trade name DER 332.

The epoxide equivalent of suitable polyepoxides may vary between 150 and 50,000, preferably between 150 and 5,000. For example, an epoxy resin based on epichlorohydrin/bisphenol-A is suitable, which has an epoxide equivalent weight of 150 to 550 g/eq.

In preferred embodiments, the epoxy resin is an epoxy prepolymer. Advantageously, this is not an epoxy resin partially cured with amine curing agents. Such partially cured epoxy resins are also referred to as B-stage epoxy resins. “Partially cured”, as used in this context, means that the resin has already been partially cured with amine curing agents, i.e. a part of the epoxide groups of the components used as starting compounds, for example monomers, has already been crosslinked by amines. Corresponding amine curing agents are known in the prior art and include, for example, aliphatic polyamines such as diethylenetriamine. In particular, the hybrid matrix system is substantially free of epoxy curing agents partially cured with amine curing agents. This has a particularly positive effect on the storage stability. In this connection, the term “substantially free from” means when the hybrid resin system contains less than 5 wt. %, preferably less than 1 wt. %, most particularly preferably less than 0.1 wt. % of the respective substances, based on the total weight, in particular does not contain the respective substances.

The polyisocyanate contains two or more isocyanate groups and includes every known isocyanate that is suitable for the purpose according to the invention, and is sometimes referred to in the following as isocyanate or isocyanate group-containing resin.

Isocyanates having two or more isocyanate groups are suitable as polyisocyanates in the polyisocyanate components. The polyisocyanates preferably contain 2 to 10, more preferably 2 to 5, even more preferably 2 to 4 and in particular 2 isocyanate groups per molecule. The use of isocyanates having a functionality of more than two can be advantageous in some circumstances since polyisocyanates of this kind are suitable as crosslinkers. Particular preference is therefore given to mixtures of compounds having 2 or more isocyanate groups, for example oligomer mixtures.

Examples of suitable polyisocyanates are 1,5-naphthylene diisocyanate, 2,4′-, 2,2′- or 4,4′-diphenylmethane diisocyanate (MDI), hydrogenated MDI (H12MDI), allophanates of MDI, xylylene diisocyanate (XDI), m- and p-tetramethylxylylene diisocyanate (TMXDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, the isomers of toluene diisocyanate (TDI), 1-methyl 2,4-diisocyanato-cyclohexane, 1,6-diisocyanato-2,2,4-trimethylhexane, 1,6-diisocyanato-2,4,4-trimethylhexane, 1-isocyanatomethyl-3-isocyanato-1,5,5 trimethylcyclohexane (IPDI), chlorinated and brominated diisocyanates, phosphorus-containing diisocyanates, 4,4′-di-isocyanatophenylperfluoroethane, tetramethoxybutane-1,4-diisocyanate, butane-1,4-diisocyanate, hexane-1,6-diisocyanate (HDI), Dicyclohexylmethane diisocyanate, cyclohexane-1,4-diisocyanate, ethylene diisocyanate, phthalic acid bis-isocyanatoethyl ester, trimethylhexamethylene diisocyanate, 1,4-diisocyanatobutane, 1,12-diisocyanatododecane and dimer fatty acid diisocyanate, and aliphatic isocyanates such as hexamethylene diisocyanate, undecane diisocyanate, dodecamethylene diisocyanate, 2,2,4-trimethylhexane-2,3,3-trimethylhexamethylene, 1,3- or 1,4-cyclohexane diisocyanate, 1,3- or 1,4-tetramethylxylene diisocyanate, isophorone diisocyanate, 4,4-dicyclohexylmethane diisocyanate or lysine ester diisocyanate.

An aromatic polyisocyanate is preferably used as the at least one polyisocyanate. In an aromatic polyisocyanate, the NCO groups are bonded to aromatic carbon atoms.

Particularly preferred are the derivatives and oligomers of 2,2′-, 2,4- and/or 4,4′-diphenylmethane diisocyanate and 2,4- or 2,6-toluene diisocyanate (TDI), di- and tetraalkyldiphenylmethane diisocyanate, 3,3′Dimethyldiphenyl-4,4′-diisocyanate (TODI) 1,3-phenylene diisocyanate, 1,4-phenylene diisocyanate and 4,4′-dibenzyl diisocyanate.

Difunctional isocyanates are preferred. However, trifunctional isocyanates can be used at least proportionally. Suitable trifunctional isocyanates are polyisocyanates which are obtained by trimerization or oligomerization of diisocyanates or by reacting diisocyanates with polyfunctional compounds containing hydroxyl or amino groups.

Accordingly, the polyisocyanate component may also contain proportions of low-molecular-weight prepolymers, for example reaction products of MDI or TDI having low-molecular-weight diols or triols such as, for example, ethylene glycol, diethylene glycol, propylene glycol, dipropylene glycol, triethylene glycol, glycerol or trimethylolpropane. These prepolymers can be prepared by reacting an excess of monomeric polyisocyanate in the presence of diols or triols. In this case, the number average molecular weight of the diols and triols is generally below 1000 g/mol. The reaction product may optionally be freed from monomeric aromatic isocyanates by distillation.

The at least one polyisocyanate preferably has an NCO content of more than 25 wt. %, more preferably more than 28 wt. %, particularly preferably more than 30 wt. %, more particularly preferably from 30 to 50 wt. %, based on the at least one polyisocyanate. When using only one polyisocyanate, the mass proportion refers to the amount of this polyisocyanate that is used; in contrast, when using a mixture of polyisocyanates, it refers to the amount of the mixture of these polyisocyanates that is used.

The at least one polyisocyanate preferably has a viscosity of less than 80 mPas, in particular from 30 to 60 mPas (DIN ISO 2555, Brookfield viscometer RVT, spindle no. 3, 25° C.; 50 rpm).

It is particularly preferable for the at least one polyisocyanate to have a number average molecular weight of less than 1500 g/mol, more preferably less than 1000 g/mol.

Particularly suitable isocyanate group-containing resins are methylene diphenyl diisocyanate (MDI), toluol-2,4-diisocyanate (TDI), polymeric diphenylmethane diisocyanate (PMDI) and mixtures thereof. These polyisocyanates are commercially available for example under the trade name Desmodur® from Bayer AG (DE).

Furthermore, at least one polyol is used, in particular at least one triol. “Polyols”, as used herein, refers to compounds which have at least 2 hydroxyl groups (—OH) per molecule. For example, the at least one polyol can have 2 or more hydroxyl groups, i.e. 3, 4, 5, 6, 7, 8, 9, 10, or more, and can have a cyclic, linear or branched structure. The polyols according to the invention may all be known in the prior art and may be suitable polyols according to the invention, in particular the polyols known from polyurethane technology with a number average molecular weight of up to 10,000 g/mol. In various embodiments, the polyol may have a number average molecular weight of from 100 to 10,000 g/mol, for example from 120 to 6,000 g/mol, from 120 to 4,000 g/mol, from 120 to 2,000 g/mol, from 120 g/mol to 1,000 g/mol, from 200 g/mol to 6,000 g/mol, from 200 g/mol to 4,000 g/mol, from 200 g/mol to 2,000 g/mol, from 200 g/mol to 1,000 g/mol. They can be selected, for example, based on polyethers, polyesters, polyolefins, polyacrylates or polyamides, these polymers each having to have at least 2 OH groups.

Unless indicated otherwise, the molecular weights indicated in the present text refer to the number average of the molecular weight (Mₙ). The number average molecular weight can be determined by gel permeation chromatography according to DIN 55672-1:2007-08 with THF as the eluent. Except where indicated otherwise, all molecular weights indicated are those that have been determined by means of GPC.

In particular, the polyols are selected such that the end viscosity desired for the hybrid resin is obtained, in particular triols are suitable for this purpose.

Suitable polyether polyols are, for example, linear or branched polyethers which have a plurality of ether bonds and which contain at least two alcohol groups, preferably at the chain ends. They contain essentially no functional groups other than the OH groups. Such polyether polyols are formed as reaction products of low molecular weight polyfunctional alcohols with alkylene oxides. The alkylene oxides preferably have 2 to 4 carbon atoms. Suitable examples are the reaction products of ethylene oxide, propylene oxide, butylene oxide or mixtures thereof with aliphatic diols, such as ethylene glycol, 1,2-propanediol, 1,3-propanediol, the isomeric butanediols, such as 1,2-butanediol, 1,3-butanediol, 1,4-butanediol and 2,3-butanediol, pentanediols and hexanediols, 2,2-dimethyl-1,3-propanediol, 2-methylpropanediol, polyglycerol, 1,6-hexanediol, 2,4,4-trimethylhexanediol-1,6,2,2,4-trimethylhexanediol-1,6,1,4-cyclohexanedimethanol, or aromatic diols, such as 4,4′-dihydroxy-diphenylpropane, bisphenol A, bisphenol F, pyrocatechol, resorcinol, hydroquinone or mixtures of two or more of that. Further polyols that are suitable in the context of the invention result from polymerization of tetrahydrofuran (polyTHF). Furthermore, the reaction products of polyfunctional alcohols such as glycerol, trimethylolethane or trimethylolpropane, pentaerythritol or sugar alcohols with the alkylene oxides are also suitable. They have the same number of terminal OH groups as the starting alcohol.

Instead of or together with the polyether polyols, polyester polyols can also be used. These are formed by a polycondensation reaction of a polyvalent alcohol having, for example, 2 to 15 C atoms and preferably 2 or 3 OH groups with one or more polycarboxylic acids, preferably those having 2 to 14 C atoms (including the C atoms of the carboxyl groups) and 2 to 6 carboxyl groups. Dicarboxylic acids which together with diols lead to linear polyester diols or triols to branched polyester triols are preferred. Conversely, branched polyester triols can also be obtained by reacting a diol with a tricarboxylic acid. As the alcohol component of the polyester polyol, there can be used, for example: Ethylene glycol, 1,2-propanediol, 1,3-propanediol, the isomeric butanediols, pentanediols, hexanediols, 2,2-dimethyl-1,3-propanediol, 2-methylpropanediol, 1,6-hexanediol, 2,4,4-trimethylhexanediol-1,6,2,2,4-trimethylhexanediol-1,6, cyclohexanediol-1,4,1,4-cyclohexanedimethanol, or aromatic diols, such as 4,4′-dihydroxydiphenylpropane, bisphenol A, bisphenol F, pyrocatechol, resorcinol, hydroquinone. Suitable carboxylic acids are, for example: Phthalic acid, isophthalic acid, terephthalic acid, maleic acid, dodecylmaleic acid, octadecenylmaleic acid, fumaric acid, aconitic acid, 1,2,4-benzenetricarboxylic acid, 1,2,3-propanetricarboxylic acid, malonic acid, succinic acid, glutaric acid, adipic acid, pimelic acid, sebacic acid, cyclohexane-1,2-dicarboxylic acid, 1,4-cyclohexadiene-1,2-dicarboxylic acid and others. Instead of the carboxylic acids the anhydrides thereof can also be used.

Because of the crosslinking behavior that is particularly suitable for the application according to the invention, it is preferred to use diisocyanates in combination with trifunctional polyols (triol) and/or aliphatic diols. In a preferred embodiment of the present invention, it has proved to be advantageous if the at least one polyol has a polyether structure. These are, for example, the corresponding derivatives of polyethylene glycol, polypropylene glycol and/or polytetrahydrofuran. The polyol according to the invention is preferably selected from the group consisting of polyethylene glycol, polypropylene glycol, polytetramethylene glycol, polyhexamethylene glycol and mixtures thereof. The polyol is particularly preferably selected from the group consisting of polyethylene glycol, polypropylene glycol or mixtures thereof and the polyol is more preferably propylene glycol. Further preferred are mixtures of trifunctional polyols, in particular trifunctional polyether polyols, and the abovementioned (linear) polyether polyols, in particular polyethylene glycol and polypropylene glycol, very particularly polypropylene glycol.

Furthermore, it has proved to be advantageous if the at least one polyol, in particular the at least one triol, particularly preferably the at least one triol and the at least one diol, has a molecular weight (Mn) of less than 10,000 g/mol, preferably from 120 to 6,000 g/mol, in particular 150 to 3,000 g/mol, very particularly preferably 180 to 1,000 g/mol. Particularly preferred is a polyether triol having an average molecular weight of 200 to 500 g/mol and/or more preferably a polypropylene glycol (diol) having an average molecular weight of 150 to 2,100 g/mol, in particular 180 to 500 g/mol.

The at least one polyisocyanate and the at least one polyol are reacted according to the invention to form a polyurethane. In this case, the polyisocyanates or the polyols are used in amounts such that the ratio of isocyanate equivalent weight to hydroxy equivalent weight according to the invention is preferably in the range of 1:1.5 to 1.5:1, more preferably 1.2:1 to 1:1.2, most preferably about 1:1. The polyisocyanates or the polyols are preferably used in amounts such that no excess of isocyanate groups is present. This could lead to blistering.

The proportion by weight of the at least one polyol based on the total mass of the epoxide/isocyanate/polyol constituents used is usually from 5.0 to 50.0 wt. %, preferably from 10 to 35 wt. %. This may depend on the at least one polyol and its chemical and physical properties as well as the desired physical and chemical properties of the cured composition. In a preferred embodiment, the hybrid resin system contains 2.0 to 30.0 wt. %, preferably 5.0 to 20.0 wt % polyol, based on the total weight.

The weight ratios of the at least one epoxy resin and the at least one polyisocyanate can likewise be varied and depends on the compounds used in each case and the chemical and physical properties thereof and on the desired physical and chemical properties of the cured composition. In general, the epoxide is used in amounts of from 20 to 70 wt. %, more preferably from 35 to 55 wt. %, based on the total mass of the epoxide/isocyanate/polyol components used. In a preferred embodiment, the hybrid resin system contains 10.0 to 40.0 wt. %, preferably 15.0 to 30.0 wt. % polyol, based on the total weight.

The at least one polyisocyanate is preferably used in amounts which result according to the molar ratios of isocyanate to hydroxyl groups given above. In general, the polyisocyanate is used in amounts of 10 to 50 wt. %, more preferably 15 to 40 wt. %, based on the total mass of the epoxide/isocyanate/polyol components used. In a preferred embodiment, the hybrid resin system contains 5.0 to 30.0 wt. %, preferably 8.0 to 20.0 wt. % epoxide, based on the total weight.

Furthermore, it is essential to the invention that the hybrid resin system contains a latent curing agent for epoxy prepolymers or epoxy resins. A latent (or also thermally activatable) curing agent may be understood according to the invention to mean compounds which can be stored at 22° C. together with the epoxy prepolymer without the curing reaction beginning to any significant extent. Only above 80° C., preferably above 100° C., the molecular structure or the state of matter of the latent curing agent changes, so that above this temperature such compounds act as a curing agent and start and/or accelerate the polymerization reaction of the epoxy prepolymers. It is preferred according to the invention that the latent curing agents are selected such that they are activated only at the temperatures which are used when pressing the resin compositions, i.e. at temperatures above 120° C. This ensures that the curing agents are not already activated in the course of exothermic polyurethane formation.

The latent curing agents may be selected, for example, from the following compounds: Guanidines, substituted guanidines, substituted ureas, melamine resins, guanamine derivatives, cyclic tertiary amines, aromatic amines and/or mixtures thereof. In this case the curing agents may be involved stoichiometrically in the curing reaction, but they may also be catalytically active. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, hepamethylisobiguanidine, and more particularly cyanoguanidine (dicyandiamide). Representatives of suitable guanamine derivatives include alkylated benzoguanamine resins, benzoguanamine resins or nnethoxymethylethoxymethylbenzoguanamine. Furthermore, 3,3-diaminodiphenylsulfone and 4,4-diaminodiphenylsulfone and their derivatives or ionic liquids (imidazolium salts) such as Baxxodur® ECX-2450 can be used as latent curing agents. Furthermore, those available under the trade names Ancamine® 2014, Ancamine® 2337, Adeka® EH-4357 and Adeka® EH-4360 are preferred according to the invention. Also, microencapsulated systems, such as those sold under the trade name Novacure® by Asahi Denka, are preferred according to the invention.

Furthermore, phenolic curing agents, such as those sold by Hexion under the trade name Durite® (in particular Durite®SD 1713 and Durite® SC-1008), are suitable according to the invention.

Another group of preferred curing agents are the imidazoles, the anhydrides and their common adducts. Preferred imidazoles according to the invention are the imidazoles unsubstituted at the N atom, such as, for example, 2-phenyl-4-methylimidazole, 2-phenylimidazole and imidazole. Further imidazole components preferred according to the invention are the alkyl-substituted imidazoles, N-substituted imidazoles and mixtures thereof.

Preferred anhydrides according to the invention are the cycloaliphatic anhydrides, such as pyromellitic dianhydride, commercially available as PMDA from Aldrich. Further preferred anhydrides are methylhexahydrophthalic anhydride (commercially available as MHHPA from Lonza Inc. Intermediates and Actives), methyltetrahydrophthalic anhydride, nadicmethylanhydride, hexahydrophthalic anhydride, tetrahydrophthalic anhydride, phthalic anhydride, dodecylsuccinic anhydride, bisphenyldianhydrides, benzophenone tetracarboxylic dianhydrides, and mixtures thereof.

Particularly preferred imidazole-anhydride adducts are a complex of 1 part of 1,2,4,5-benzenetetracarboxylic anhydride and 4 parts of 2-phenyl-4-methylimidazole, and a complex of 1 part of 1,2,4,5-benzenetetracarboxylic dianhydride and 2 parts 2-phenyl-4-methylimidazole. The adducts are obtained by dissolving the components in a suitable solvent, such as acetone, under the action of heat. After cooling, the product precipitates out of the solution.

Nadicmethyl anhydride (methyl-5-norbornene-2,3-dicarboxylic anhydride) is a preferred anhydride curing agent.

Preference is furthermore given to using epoxy-amine adducts as latent curing agents, such as those obtainable, for example, under the trade name Ajicure®.

According to the invention, the latent curing agents are preferably present in an amount of from 0.5 to 10 wt. %, in particular from 1 to 5 wt %, based in each case on the resulting application preparation, i.e. the hybrid resin system.

In addition to the aforementioned curing agents, it is possible according to the invention to use catalytically active substituted ureas as accelerators. These are in particular the p-chlorophenyl-N, N-dimethylurea (monuron), 3-phenyl-1,1-dimethylurea (Fenuron) or 3,4-dichlorophenyl-N, N-dimethylurea (diuron). In principle, it is also possible to use catalytically active tertiary acrylic or alkyl amines, for example the benzyldimethylamine, tris (dimethylamino) phenol, piperidine or piperidine derivatives. These may also preferably be present in a polymer matrix such as a phenolic resin.

Furthermore, various, preferably solid imidazole derivatives can be used as catalytically active accelerators. Representative examples include 2-ethyl-2-methylimidazole, N-butylimidazole, benzimidazole and N—C1 to C12-alkylimidazoles or N-arylimidazoles. Furthermore, adducts of amino compounds to epoxy resins are suitable as accelerating additives to the aforementioned curing agents. Suitable amino compounds are tertiary aliphatic, aromatic or cyclic amines. Suitable epoxy compounds are, for example, polyepoxides based on glycidyl ethers of bisphenol A or F or of resorcinol. Specific examples of such adducts are adducts of tertiary amines such as 2-dimethylaminoethanol, N-substituted piperazines, N-substituted homopiperazines, N-substituted aminophenols to di- or polyglycidyl ethers of bisphenol A or F or of resorcinol.

In the context of the present invention, it is preferred, but not mandatory, for the hybrid resin system additionally to contain such a curing accelerator for epoxide prepolymers, in particular adducts of amino compounds with epoxy resins or derivatives of urea, such as, for example, fenuron.

The curing accelerators for epoxy prepolymers according to the invention are preferably in an amount of 0.01 to 1 wt. %, in particular from 0.05 to 0.5 wt. %, each based on the resulting hybrid resin composition.

Finally, the hybrid resin system for accelerating the polyurethane formation additionally contains a curing catalyst for isocyanates. For example, dialkyltin dicarboxylates are suitable for this purpose, for example dibutyltin dicarboxylates. The carboxylate groups can be selected from those with a total of (i.e. including the carboxyl group) 2 to 18 carbon atoms. Suitable carboxylic acids for the formation of the carboxylates are, for example, acetic acid, propionic acid, butyric acid, valeric acid, caproic acid, caprylic acid, capric acid, lauric acid, palmitic acid and stearic acid. In particular, dibutyltin dilaurate is suitable. Furthermore, organometallic compounds based on bismuth and zinc such as, for example, bismuth zinc neodecanoate can be used. Furthermore, it may be preferable to use curing catalysts for isocyanates, the activity of which is retarded relative to the free catalyst, that is to say whose activity greatly increases, for example due to the action of heat. An example of such curing catalysts are thermally decomplexing metal chelates. One embodiment is, for example, pentane-2,4-dione-added zirconium chelate K-Kat A209 from King Industries.

According to the invention such curing catalysts for isocyanates are preferably included in an amount of 0 to 3 wt. %, in particular from 0.02 to 0.5 wt. %, each based on the resulting application preparation.

The urethane reaction is carried out by mixing the polyol and isocyanate components and the catalyst in the presence of the at least one epoxy resin to obtain the corresponding epoxy/polyurethane hybrid resin. Suitable mixers and methods are known in the prior art. Furthermore, the further constituents of the hybrid resin compositions may also be present, for example the latent curing agent for the epoxide and optionally fillers and/or other auxiliaries. When the latent curing agent is contained, it is critical that the temperature of the composition during the urethane reaction does not rise to a temperature that activates the latent curing agent.

In various embodiments, the resin system includes, in addition to the epoxide, the polyurethane, and the latent curing agent, additional ingredients that are known and customary in the prior art.

For example, in a preferred embodiment, the hybrid resin contains at least one toughener. Such tougheners improve the fracture behavior of the fiber composites available from the resin systems of the invention and are known to those skilled in the epoxy adhesives art. For example, they may be selected from: thermoplastic isocyanates or polyurethanes, rubber particles, in particular those having a core-shell structure, and block copolymers, in particular those containing a first polymer block having a glass transition temperature below 15° C. and a second polymer block having a glass transition temperature of above 25° C. Such block copolymers are preferably selected from those in which a first polymer block is selected from a polybutadiene or polyisoprene block and a second polymer block is selected from a polystyrene or a polymethyl methacrylate block. Specific examples of these are block copolymers with the following block structure: Styrene-butadiene (meth)acrylate, styrene-butadiene (meth)acrylic acid esters, ethylene (meth)acrylic acid esters, glycidyl (meth)acrylic acid ester, ethylene (meth)acrylic acid ester maleic anhydride, methyl methacrylate, butyl acrylate methyl methacrylate.

Furthermore, “tougheners” preferred according to the invention are rubber particles with core-shell structure, which have a core of a polymer material having a glass transition temperature of below 0° C. and a shell of a polymer material having a glass transition temperature of above 25° C.

Particularly suitable rubber particles having a core-shell structure may comprise a core of a diene homopolymer, a diene copolymer or a polysiloxane elastomer and/or a shell of an alkyl (meth)acrylate homopolymer or copolymer.

For example, the core of these core-shell particles may contain a diene homopolymer or copolymer which may be selected from a homopolymer of butadiene or isoprene, a copolymer of butadiene or isoprene with one or more ethylenically unsaturated monomers such as vinylaromatic monomers, (meth)acrylonitrile, (meth)acrylates or similar monomers. The polymer or copolymer of the shell may contain as monomers, for example: (Meth)acrylates, such as in particular methyl methacrylate, vinyl aromatic monomers (for example styrene), vinyl cyanides (for example acrylonitrile), unsaturated acids or anhydrides (for example acrylic acid), (meth)acrylamides and similar monomers which lead to polymers having a suitable high glass transition temperature.

The shell polymer or copolymer may have acid groups that can crosslink by metal carboxylate formation, for example by salification with divalent metal cations. Furthermore, the shell polymer or copolymer may be covalently crosslinked by employing monomers having two or more double bonds per molecule.

As the core, other rubbery polymers may be used, such as polybutyl acrylate or polysiloxane elastomers such as polydimethylsiloxane, especially crosslinked polydimethylsiloxane.

Typically, these core-shell particles are constructed such that the core accounts for 50 to 95 wt. % of the core-shell particle and the shell accounts for 5 to 50 wt. % of this particle.

Preferably, these rubber particles are relatively small. For example, the average particle size (as determinable, for example, by light scattering methods) may range from about 0.03 to about 2 μITI, more preferably in the range from about 0.05 to about 1 μITI. However, smaller core-shell particles may also be used, for example, those having an average diameter of less than about 500 nm, more preferably less than about 200 nm. For example, the average particle size may range from about 25 to about 200 nm.

The preparation of such core-shell particles is known in the prior art, as indicated for example in WO 2007/025007 on page 6, lines 16 to 21. Commercial sources of such core shell particles are listed in this document in the last paragraph of page 6 through the first paragraph of page 7. Reference is hereby made to these sources. Furthermore, reference is made to manufacturing methods for such particles, which are described in the said document from page 7, 2nd paragraph to page 8, 1st paragraph. For further information on suitable core-shell particles, reference is also made to said document WO 2007/025007, which contains detailed information on page 8, line 15 to page 13, line 15.

The same function as the above-mentioned rubber particles having a core-shell structure can be performed by inorganic particles having a shell of organic polymers.

In such an embodiment, the resin system used in the present invention preferably contains inorganic particles having an organic polymer shell, wherein the organic polymers are selected from homo- or copolymers of acrylic acid and/or methacrylic acid ester and consist of at least 30 wt. % of polymerized acrylic acid and/or methacrylic acid ester. For a more detailed description of the inorganic particles, reference is made at this point to WO 2012/139975 A1, pages 20-22.

The tougheners are preferably contained in an amount of 0 to 50 wt. %, in particular from 5 to 20 wt. %, each based on the resulting application preparation.

In various embodiments of the present invention, it may be preferred if the resulting application preparation, i.e. the ready-to-use resin system, contains at least one filler.

In general, the known fillers such as the various milled or precipitated chalks, carbon black, calcium magnesium carbonates, talc, kaolins, barite, and in particular silicate fillers of the type of aluminum-magnesium-calcium silicate, for example wollastonite, bentonite, chlorite, are preferred according to the invention.

To reduce weight, the resin system may contain so-called lightweight fillers in addition to the above-mentioned “normal” fillers. Lightweight fillers are characterized according to the invention in that they have a lower density than the preparation into which they are incorporated, and thus their addition reduces the density of the preparation. Such lightweight fillers can be selected from the group of hollow metal spheres such as glass bubbles, fly ash (Fillite), hollow plastic spheres based on phenolic resins, epoxy resins or polyesters, expanded hollow microspheres with wall material of (meth)acrylic acid ester copolymers, polystyrene, styrene (meth)acrylate copolymers and in particular of polyvinylidene chloride and copolymers of vinylidene chloride with acrylonitrile and/or (meth)acrylic acid esters, ceramic hollow spheres or organic lightweight fillers of natural origin such as ground nut shells, for example the shells of cashew nuts, coconuts or peanut shells and cork powder or coke powder. Particular preference is given to those lightweight fillers based on hollow microspheres, which ensure a high compressive strength of the molding in the cured molding matrix. Furthermore, carbon nanotubes are considered as suitable fillers.

The fillers (normal fillers and lightweight fillers together) are contained in the resulting application preparations preferably in amounts of 0 to 70 wt. %, in particular from 10 to 60 wt %, each based on the resulting application preparation.

It may be advantageous that the fillers have an average particle size of less than 150 nm.

Furthermore, the resin systems used according to the invention may optionally contain conventional further auxiliaries and additives such as, for example, plasticizers, rheology aids, internal release agents, wetting agents, adhesion promoters, aging inhibitors, stabilizers and/or color pigments. Depending on the requirement profile in terms of processing properties, the flexibility, the required stiffening effect and the adhesive bond to the substrates, the proportions of the individual components can vary within relatively wide limits.

The resin systems described herein are particularly suitable as matrix resins for use in SMCs. For this purpose, the hybrid resins, such as have been described above, can be used as a molding compound and as such can be pressed with the fibers. In known SMC processes, the resin compositions are applied, for example in the form of pastes or dough-like masses, and the fibers are applied to a carrier film, after which the pressing takes place. The application of the fibers can take place, for example, between two layers of the resin composition. This composite is covered with another carrier foil and is then pressed with compacting rollers. The pressing takes place at a temperature of 130 to 170° C., usually 150 to 160° C. This temperature is sufficient to activate the latent curing agent and thus to completely cure the epoxy resin.

An object of the invention is a method for the production of fiber composite materials, in particular by means of SMC methods, characterized in that a hybrid resin system comprising:

(1) at least one epoxy resin,

(2) at least one polyurethane; wherein the at least one polyurethane is obtainable by reacting a reaction mixture comprising:
(a) at least one polyisocyanate;
(b) at least one polyol; and
(c) at least one catalyst for the synthesis of polyurethane; and

(3) at least one latent curing agent for the epoxy resin;

is compressed with a suitable fiber material at elevated temperature and thereby cured, wherein the hybrid resin system, in particular at a temperature of 150° C. has a viscosity of at least 100 Pas, preferably at least 500 Pas and advantageously comprises the other above-mentioned preferred embodiments.

Known high-performance fiber materials are suitable as fiber components of the fiber composite materials. These can consist, for example, of: glass fibers; synthetic fibers, such as polyester fibers, polyethylene fibers, polypropylene fibers, polyamide fibers, polyimide fibers or aramid fibers; carbon fibers; boron fibers; oxide or non-oxide ceramic fibers, such as aluminum oxide/silicon dioxide fibers, silicon carbide fibers; metal fibers, for example made of steel or aluminum; or of natural fibers, such as flax, hemp or jute. Said fibers can be incorporated in the form of mats, woven fabrics, knitted fabrics, non-woven fabrics, fibrous webs or rovings. Two or more of these fiber materials may also be used as a mixture. Short cut fibers can be selected, but preferably synthetic long fibers are used, in particular woven and non-woven fabrics. Such high strength fibers, non-woven fabrics, woven fabrics and rovings are known to a person skilled in the art.

According to the invention, the fibers are preferably initially introduced in such an amount that their volume fraction in the finished fiber composite material is from 30 to 75 vol. %. In particular, the fiber composite material should contain fibers in a proportion by volume of more than 40 vol. %, preferably more than 50 vol. %, particularly preferably between 50 and 70 vol. %, based on the total fiber composite material, in order to achieve particularly good mechanical properties. In the case of carbon fibers, the proportion by volume is determined according to the standard DIN EN 2564:1998-08 and in the case of glass fibers it is determined according to the standard DIN EN ISO 1172:1998-12.

In addition to the use of the resin systems described herein as the matrix resin for making SMCs or in SMC applications, the invention also relates to SMC methods employing the hybrid resin systems described herein. In these methods for producing fiber matrix composites, the resin compositions described herein are compressed with suitable fibers at elevated temperature and are thereby cured.

The present invention also relates to the cured fiber composites obtainable by the method described above as well as structural or molded parts containing such a fiber composite material according to the invention. Due to the wide range of processing options, fiber composites according to the invention can be processed in a variety of components. A fiber composite material of this kind is suitable in particular as an automobile part. Compared with steel, such fiber composite components have several advantages, i.e. they are lighter in weight, are characterized by improved crash resistance and are also more durable.

The present invention further relates to pre-cured fiber composites obtainable by the methods described above, wherein the curing is not complete. Such a pre-cured fiber composite based on the hybrid matrix system according to the invention is particularly stable in storage, even at room temperature and can be cured or pressed only after several weeks in its final desired shape to obtain the desired material properties, especially for the automotive sector.

Moreover, it goes without saying that all embodiments that have been disclosed above in connection with the method according to the invention can also be applied in the same manner in the described resin systems and cured compositions, and vice versa.

### EXAMPLES

First of all, all raw materials which were liquid at room temperature from Table 1 were mixed in the speed mixer for 2 minutes at 2000 revolutions per minute in vacuo. In a second step, fillers and other solid constituents were mixed in as well. After the mixture had cooled back to room temperature, the catalyst for the polyurethane reaction was mixed for 1 min at 2000 revolutions per minute under vacuum. Subsequently, the mixtures were pre-cured for 1 h at 80° C. in a convection oven. After this pre-curing, the temperature-dependent viscosity of the hybrid resin system was determined by means of a plate/plate rheometer at a heating rate of 10 K/s in the range of 20 to 200° C. in oscillation at 100 rad/s at a deformation of 1%.

TABLE 1

| | 1 | 2 | 3 | 4 | 5 |
|---|---|---|---|---|---|
| DER 331 (epoxy resin prepolymer) | 21.31 | 22.83 | 21.97 | 26.74 | 26.74 |
| PEG 200 | — | — | — | 5.00 | 3.00 |
| PPG2000 | 4.90 | 12.81 | 12.32 | — | — |
| Trifunctional polyether polyol | 8.73 | 4.27 | 4.93 | 5.00 | 3.00 |
| (Mn ~300 g/mol | | | | | |
| MDI/PMDI from Desmodur | 14.37 | 9.20 | 9.92 | 15.32 | 10.12 |
| Filler (Omyacarb 4HD) | 49.00 | 49.10 | 49.13 | 54.10 | 44.90 |
| DBTL (dibutyltin dilaurate) | 0.1 | 0.09 | 0.08 | 0.11 | 0.09 |
| Dyhard 100SH (dicyandiamide) | 1.49 | 1.60 | 1.54 | 1.87 | 1.87 |
| Dyhard UR300 (Fenuron) | 0.11 | 0.11 | 0.11 | 0.13 | 0.13 |
| Viscosity at RT | OK | OK | OK | OK | OK |
| Viscosity at 150° C. | OK | OK | OK | OK | OK |

MDI: methylene diphenyl isocyanate
PMDI: polymeric methylene diphenyl isocyanate
PEG: polyethylene glycol
PPG: polypropylene glycol
DER 331: epoxy resin (diglycidyl ether of bisphenol A), Dow Chemical

The hybrid resin systems of Examples 1 to 5 exhibited excellent viscosity properties both at RT and at 150° C., which are particularly suitable for SMC. The hybrid resin systems of Examples 4 and 5 showed particularly advantageous material properties in the cured fiber composites.

What is claimed is:

1. A curable epoxy/polyurethane hybrid resin system for SMC (sheet molding compound), characterized in that the hybrid resin system comprises:
(1) at least one epoxy resin,
(2) at least one polyurethane; wherein the at least one polyurethane is obtainable by reacting a reaction mixture comprising:
(a) at least one polyisocyanate;
(b) at least one polyol; and
(c) at least one catalyst for the synthesis of polyurethane; and
(3) at least one latent curing agent for the epoxy resin;
wherein the hybrid resin system at a temperature of 150° C. has a viscosity of at least 100 Pas.

2. The hybrid resin system according to claim 1, characterized in that the at least one epoxy resin is a prepolymer based on at least one glycidyl ether, in particular an aromatic diglycidyl ether, particularly preferably a bisphenol diglycidyl ether.

3. The hybrid resin system according to claim 1, characterized in that the at least one polyisocyanate is an aromatic polyisocyanate, in particular methylene diphenyl diisocyanate (MDI) or polymeric methylene diphenyl diisocyanate (PMDI).

4. The hybrid resin system according to claim 1, characterized in that the at least one polyol is selected from the group consisting of polyether polyol, polyester polyol and mixtures thereof and/or at least one triol is contained as polyol.

5. The hybrid resin system according to claim 4, characterized in that the at least one polyol
(a) is selected from the group consisting of polyethylene glycol, polypropylene glycol, polytetramethylene glycol, polyhexamethylene glycol and mixtures thereof, preferably from the group consisting of polyethylene glycol, polypropylene glycol and mixtures thereof and more preferably is propylene glycol; and/or
(b) has a number average molecular weight Mₙ of less than 10,000 g/mol, preferably from 120 to 6000 g/mol, in particular 150 to 3000 g/mol, very particularly preferably from 180 to 1000 g/mol; and or
(c) comprises at least one linear polyether polyol, in particular polyethylene glycol or polypropylene glycol, and at least one trifunctional polyol, in particular trifunctional polyether polyol.

6. The hybrid resin system according to claim 1, characterized in that
(a) the latent curing agent is activated only at temperatures above 120° C.; and or
(b) the polyurethane synthesis catalyst is an organotin compound, especially dibutyltin dilaurate (DBTL).

7. A use of the hybrid resin system according to claim 1 as matrix resin in SMCs.

8. A method for the production of fiber composites by means of SMC methods, characterized in that a hybrid resin system comprising:
(1) at least one epoxy resin,
(2) at least one polyurethane; wherein the at least one polyurethane is obtainable by reacting a reaction mixture comprising:
(a) at least one polyisocyanate;
(b) at least one polyol; and
(c) at least one catalyst for the synthesis of polyurethane; and
(3) at least one latent curing agent for the epoxy resin is pressed with a suitable fiber material at elevated temperature and is thereby cured.

9. A fiber composite obtainable according to the method of claim 8.

10. Structural or molded material containing the fiber composite material according to claim 9.
